(19) United States
(12) Patent Application Publication
(10) Pub. No.: US 2015/0326526 A1
(43) Pub. Date: Nov. 12, 2015

(54) KEEPING A TERMINAL ACCESS LOCATION RECORD ALIVE

(71) Applicant: HANGZHOU H3C TECHNOLOGIES CO., LTD., Hangzhou, Zhejiang (CN)

(72) Inventors: Yonggang ZENG, Beijing (CN); Ruili TIAN, Beijing (CN)

(73) Assignee: Hangzhou H3C Technologies Co., Ltd., Hangzhou City (CN)

(21) Appl. No.: 14/651,176

(22) PCT Filed: Jan. 10, 2014
(86) PCT No.: PCT/CN2014/070442

§ 371 Date: Jun. 10, 2015

(30) Foreign Application Priority Data
Jan. 24, 2013 (CN) 201310030197.9

(51) Int. Cl. H04L 29/12; H04L 12/741

(52) U.S. Cl. CPC H04L 61/1552; H04L 61/103; H04L 45/745

(57) ABSTRACT

A SDN controller may receive a packet from a terminal device and may update an IP/MAC address mapping record and a terminal access location record of the terminal device. The SDN controller may periodically send an ARP request packet and may keep the IP/MAC address mapping record and the terminal access location record of the terminal device alive. The SDN controller may also periodically age the IP/MAC address mapping record and the terminal access location record of the terminal device.

### BACKGROUND

With the continued development of Internet services, shorter and shorter amounts of time are needed to deploy an Internet service. For example, a few years ago, it usually took several months and a large amount of manpower to deploy an Internet service. At present, an Internet service may be deployed in several days and with little manpower. New technologies, such as software defined network (SDN), assist in the rapid development of Internet services. In a SDN model, an Internet service may be deployed via software, thereby decreasing manpower and time requirements. Numerous SDN technologies have been developed, an example of which is OpenFlow.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating the structure of an SDN, according to an example of the present disclosure.

FIG. 2 is a schematic flowchart illustrating a method of keeping a terminal access location record alive, according to an example of the present disclosure.

FIG. 3 is a schematic flowchart illustrating a method of updating a terminal access location record of the terminal device according to an example of the present disclosure.

FIG. 4 is a schematic flowchart illustrating a method of updating an IP/MAC address mapping record according to an example of the present disclosure.

FIG. 5 is a schematic flowchart illustrating a method of aging the IP/MAC address mapping record and the terminal access location record of the terminal device according to an example of the present disclosure.

FIG. 6 is schematic diagram illustrating an IP/MAC address mapping record according to an example of the present disclosure.

FIG. 7 is schematic diagram illustrating a terminal access location record according to an example of the present disclosure.

FIG. 8 is schematic diagram illustrating a scenario of keeping a terminal access location record alive, according to an example of the present disclosure.

FIG. 9 is a schematic diagram illustrating a device of keeping a terminal access location record alive, according to another example of the present disclosure.

FIG. 10 is a schematic diagram illustrating a device of keeping a terminal access location record alive, according to a further example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

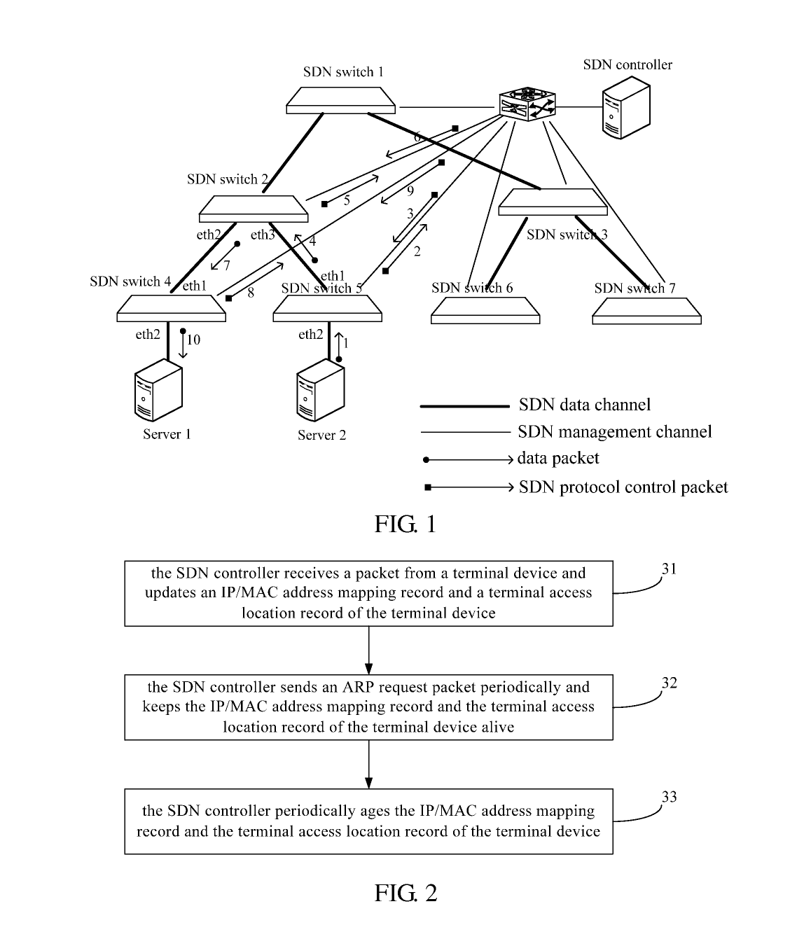

FIG. 1 is a schematic diagram illustrating the structure of a SDN, such as an OpenFlow network. In the SDN of FIG. 1, one SDN switch is depicted as not only being connected to other SDN switches via data forwarding links, but is also depicted as being connected to a SDN controller via a separate management channel. Specifically, the data forwarding links may be SDN data channels, while the management channel may be a SDN management channel. As illustrated in FIG. 1, a terminal device may access the SDN via a switch port of a SDN switch, in which the terminal device may be a server, a personal computer (PC), a printer, an IP phone, etc. It should be noted that a terminal access location record table may be adopted by the SDN controller to record the access location of each terminal device within a SDN. In other words, the terminal access location record table may include at least one terminal access location record. In addition, each terminal access location record corresponds to one terminal device and records information concerning a switch port of a SDN switch via which the terminal device accesses the SDN. In an example, in the terminal access location record table, a terminal device is identified by its media access control (MAC) address. When a SDN switch receives a packet, the SDN switch may submit the packet to the SDN controller, and after a route calculation according to the terminal access location record table, the SDN controller may provide instructions to the SDN switch as to how the SDN switch is to handle the packet. For example, the SDN controller may instruct the SDN switch to discard the packet, restrict the packet, or send the packet via a certain port.

In an example, an Internet control message protocol (ICMP) request packet is sent from Server2 to Server1, as shown in FIG. 1. The process of sending the ICMP request packet from Server2 to Server1 is also shown in FIG. 1, which is described as follows.

At 1, Server2 may send the ICMP request packet to Server1 and the ICMP request packet may first reach SDN Switch5. In an example, the MAC address of Server2 is MAC2 and the MAC address of Server1 is MAC1.

At 2, SDN Switch5 may submit the ICMP request packet to a SDN controller via a SDN management channel.

At 3, the SDN controller may parse the destination MAC address of the ICMP request packet. The SDN controller may search the terminal access location record table and may find that Server1 accesses the network via Port eth2 of SDN Switch4. Then, the SDN controller may calculate a route between SDN Switch5 and SDN Switch4 and find that the ICMP request packet should be sent to SDN Switch2 via Port eth1 of SDN Switch5 first. Thereafter, the SDN controller may send an instruction to SDN Switch5 via a SDN management channel, instructing SDN Switch5 to send the ICMP request packet via Port eth1 of SDN Switch5.

At 4, SDN Switch5 sends the ICMP request packet via Port eth1 according to the instruction of the SDN controller.

At 5, after receiving the ICMP request packet, SDN Switch2 may submit the ICMP request packet to the SDN controller via a SDN management channel.

At 6, after receiving the ICMP request packet from SDN Switch2, the SDN controller may perform similar processing as those described at 3. That is, the SDN controller may parse the destination MAC address of the ICMP request packet. The SDN controller may search the terminal access location record table and may then find that Server1 accesses the network via Port eth2 of SDN Switch4. Then, the SDN controller may calculate a route between SDN Switch2 and SDN Switch4, and may find that the ICMP request packet should be sent to SDN Switch4 via Port eth2 of SDN Switch2. Thereafter, the SDN controller may send an instruction to SDN Switch2 via a SDN management channel, instructing SDN Switch2 to send the ICMP request packet via Port eth2 of SDN Switch 2.

At 7, SDN Switch2 may send the ICMP request packet via Port eth2 according to the instruction of the SDN controller.

At 8, after receiving the ICMP request packet, SDN Switch4 may submit the ICMP request packet to the SDN controller via a SDN management channel.

At 9, the SDN controller may parse the destination MAC address of the ICMP request packet. The SDN controller may search the terminal access location record table and may find that Server1 accesses the network via Port eth2 of SDN Switch4. That is, the ICMP request packet may reach its destination SDN switch. Because the terminal access location record table contains information that Server1 accesses the network via Port eth2 of SDN Switch4, the SDN controller may send an instruction to SDN Switch4 via a SDN management channel, instructing SDN Switch4 to send the ICMP request packet via Port eth2 of SDN Switch4.

At 10, SDN Switch4 may send the ICMP request packet via Port eth2 according to the instruction of the SDN controller and the ICMP request packet may reach Server1.

In the above packet forwarding process, the SDN controller may calculate the route based on a data structure, that is, the terminal access location record table. If the terminal access location record table does not contain information related to the destination MAC address, the SDN controller may have to flood (broadcast) the ICMP request packet. Or, if the information related to the destination MAC address recorded in the terminal access location record table is incorrect, the ICMP request packet may be forwarded incorrectly. Accordingly, the SDN controller may need to correctly maintain the terminal access location record table.

According to an example, the SDN controller may add the information related to the source MAC address of the packet into the terminal access location record table after parsing the source MAC address of the packet. A port of a SDN switch may be deemed as a port connected to a terminal device if the following two conditions are satisfied: (1) the SDN switch receives the packet via the port; (2) the SDN switch is connected to a terminal device rather than a SDN switch via the port. Generally, when the location of a server changes, the location record of the server in the terminal access location record table should be updated, or else the server is unable to communicate with an external device. In order to deal with the problem caused by the change of the access location of a terminal device whose MAC address is contained in the terminal access location record table, an aging process may be provided. The SDN controller may record an update time for each record of the terminal access location record table. When the SDN controller receives a packet, the SDN controller may update the update time of the record corresponding to the source MAC address contained in the packet. If, during a predetermined aging period, the SDN controller does not receive a message whose source MAC address is a specific MAC address recorded in a terminal access location record in the terminal access location record table, the SDN controller may delete the terminal access location record.

However, in the above process, if the SDN controller deletes a terminal access location record in the terminal access location record table directly, there may still be some problems. For example, if the location of Server1 corresponding to MAC1 does not change, but Server1 has not sent out a packet for a relatively long time, the terminal access location record corresponding to MAC1 (the terminal access location record of Server1) in the terminal access location record table may be deleted improperly, and thus subsequent packets sent to Server1 have to be broadcasted. In this case, if there are a large number of devices similar to Server1 in the SDN, the SDN controller may need to broadcast a large number of packets, and thus, the forwarding performance of the SDN may be greatly affected.

In examples of the present disclosure, each terminal device may periodically send Address Resolution Protocol (ARP) packets to the SDN controller. Thus, after receiving an ARP packet from a terminal device, the SDN controller may update the terminal access location record of the terminal device. As such, the terminal access location record of the terminal device may be kept alive and deletion of the information of the terminal device in the terminal access location record table may be avoided. Further, an IP/MAC address mapping record table may also be adopted by the SDN controller to record information related to the IP address and the MAC address of each terminal device within the SDN.

FIG. 2 is a schematic flowchart illustrating a method of keeping a terminal access location record alive, according to an example. The method may be applied to a SDN, and the SDN may include a terminal device, a SDN switch, and a SDN controller. The SDN may also include a plurality of terminal devices, a plurality of SDN switches, and a SDN controller. In an example, the terminal device may be a server.

At block 31, the SDN controller may receive a packet from a terminal device and may update an IP/MAC address mapping record and a terminal access location record of the terminal device. The packet from the terminal device may be sent to the SDN controller via a SDN switch, so the SDN controller may receive the packet directly or indirectly from an SDN switch. For example the packet may be received by the SDN controller over an SDN management channel linking the SDN switch and the SDN controller. The IP/MAC address mapping record is stored in g_olpMacMap of the SDN controller and the terminal access location record is stored in g_oMacLocMap of the SDN controller.

In an example, the IP/MAC address mapping record of the terminal device is an ARP table, which may be illustrated as follows.

```
    typedef struct
    {
```

| | |
|---|---|
| int ipAddr; | //IP address of the terminal device |
| _int64 macAddr; | //MAC address of the terminal device |

```
    time_t updateTime;  //address  update  time  in  the  IP/MAC
address  mapping  record,  and  if  the  difference  between  the
current  time  and  the  address  update  time  is  larger  than  an
aging  period,  the  IP/MAC  address  mapping record would be deleted
    }SIpMacRec;
    std::map<int, SIpMacRec > g_oIpMacMap, “int” indicates the IP
address of the terminal device.
```

Further, in the example above, the terminal access location record of the terminal device may be defined as follows.

```
    typedef struct
    {
```

| | |
|---|---|
| int switchIP; | //IP address of SDN switch receiving the packet |
| int port; | //port via which the SDN switch receives the packet |

```
time_t updateTime;  //location  update  time  in  the  terminal
access  location  record,  when  the  difference  between  the  current
time  and  the  location  update  time  is  larger  than  the  aging
period,  the  terminal  access  location record would be deleted
    }SLocRec;
    std::map<_int64,  SLocRec  >  g_oMacLocMap,  “_int64”
indicates  the MAC address of the terminal device.
```

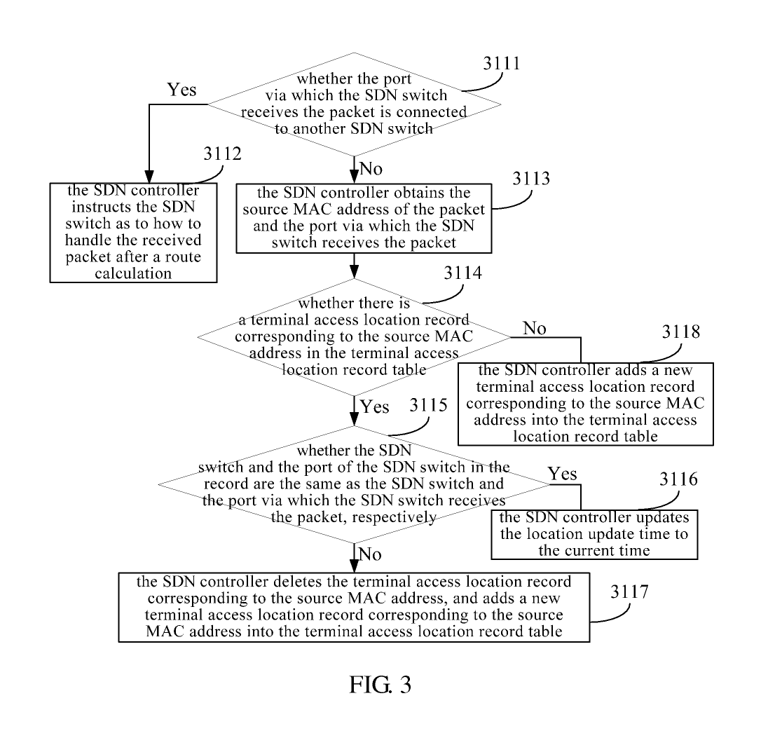

FIG. 3 is a schematic flowchart illustrating a method of updating a terminal access location record of the terminal device according to an example of the present disclosure. The method includes following blocks.

At block 3111, after obtaining a source IP/MAC address from the packet, the SDN controller may determine whether the port via which the SDN switch receives the packet is connected to another SDN switch. If the port via which the SDN switch receives the packet is connected to another SDN switch, block 3112 is performed. If the port via which the SDN switch receives the packet is not connected to another SDN switch, block 3113 is performed.

At block 3112, the SDN controller may instruct the SDN switch as to how to handle the received packet after a route calculation.

At block 3113, the SDN controller may obtain the source MAC address of the packet and the port via which the SDN switch receives the packet.

At block 3114, the SDN controller may determine whether there is a terminal access location record corresponding to the source MAC address in the terminal access location record table named g_oMacLocMap. If the terminal access location record corresponding to the source MAC address is found, block 3115 is performed. If the terminal access location record corresponding to the source MAC address is not found, block 3118 is performed.

At block 3115, the SDN controller may determine whether the SDN switch and the port of the SDN switch in the record are the same as the SDN switch and the port via which the SDN switch receives the packet, respectively. If the SDN switch and the port of the SDN switch in the record are the same as the SDN switch and the port via which the SDN switch receives the packet, respectively, block 3116 is performed. If the SDN switch in the record is different from the SDN switch receiving the packet or the port of the SDN switch in the record is different from the port via which the SDN switch receives the packet, block 3117 is performed.

At block 3116, the SDN controller updates the location update time to the current time.

At block 3117, the SDN controller may delete the terminal access location record corresponding to the source MAC address, and may add a new terminal access location record corresponding to the source MAC address into the terminal access location record table. In the new record, the source MAC address of the packet may be used as a key of the record for finding the record within the terminal access location record table, “switchIP” may be the IP address from which the packet is received, “port” may be the switch port of the SDN switch via which the SDN switch receives the packet, and “updateTime” is the current time.

At block 3118, the SDN controller may add a new terminal access location record corresponding to the source MAC address into the terminal access location record table. In the new record, the key for finding the record may be the source MAC address of the packet, “switchIP” may be the IP address from which the packet is received, “port” may be the switch port of the SDN switch via which the SDN switch receives the packet, and “updateTime” may be the current time.

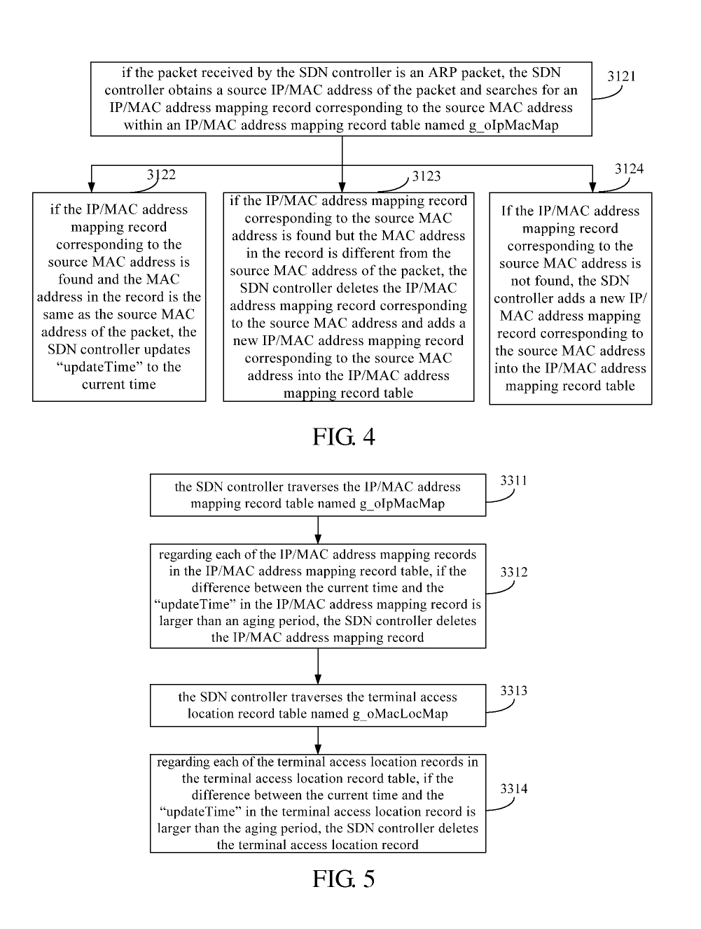

FIG. 4 is a schematic flowchart illustrating a method of updating an IP/MAC address mapping record according to an example of the present disclosure. The method includes following blocks.

At block 3121, if the packet received by the SDN controller is an ARP packet, the SDN controller may obtain a source IP/MAC address of the packet and may search for an IP/MAC address mapping record corresponding to the source MAC address within an IP/MAC address mapping record table named g_olpMacMap.

At block 3122, if the IP/MAC address mapping record corresponding to the source MAC address is found and the MAC address in the record is the same as the source MAC address of the packet, the SDN controller may update “updateTime” to the current time.

At block 3123, if the IP/MAC address mapping record corresponding to the source MAC address is found but the MAC address in the record is different from the source MAC address of the packet, the SDN controller may delete the IP/MAC address mapping record corresponding to the source MAC address and may add a new IP/MAC address mapping record corresponding to the source MAC address into the IP/MAC address mapping record table. In the new record, the key of the record, may be the source MAC address of the packet, “switchIP”, may be the source IP address, and “updateTime”, may be the current time.

At block 3124, If the IP/MAC address mapping record corresponding to the source MAC address is not found, the SDN controller may add a new IP/MAC address mapping record corresponding to the source MAC address into the IP/MAC address mapping record table. In the new record, the key, may be the source MAC address of the packet, “switchIP”, may be the source IP address, and “updateTime”, may be the current time.

At block 32, the SDN controller may send an ARP request packet periodically and may keep the IP/MAC address mapping record and the terminal access location record of the terminal device alive.

In an example of the present disclosure, the SDN controller may perform the following operations.

The SDN controller may traverse the IP/MAC address mapping record table. The IP/MAC address mapping record table may be named g_oIpMacMap.

According to the MAC address contained in the IP/MAC address mapping record of the terminal device, the SDN controller may search for the access location of the terminal device within the terminal access location record table. In an example, the IP address and the MAC address contained in the IP/MAC address mapping record of the terminal device are IP1 and MAC1 respectively.

If the access location of the terminal device is found, the SDN controller may create an ARP request packet according to the access location of the terminal device and may send out the ARP request packet via the access location of the terminal device. The destination IP address of the ARP request packet may be the IP address of the terminal device, the destination MAC address of the ARP request packet may be idle, the source IP address of the ARP request packet may be a local IP address of the SDN controller, and the source MAC address of the ARP request packet may be a local MAC address of the SDN controller. In an example, the access location of the terminal device is port1 of Switch1, and the IP address of the terminal device is IP1.

If the terminal device is still in the SDN after the ARP request packet is sent out, the terminal device may respond with an ARP response packet. After receiving the ARP response packet from the terminal device, the SDN controller may update the IP/MAC address mapping record and the terminal access location record of the terminal device.

At block 33, the SDN controller may periodically age the IP/MAC address mapping record and the terminal access location record of the terminal device. In addition, the SDN controller may perform the following operations.

FIG. 5 is a schematic flowchart illustrating a method of aging the IP/MAC address mapping record and the terminal access location record of the terminal device according to an example of the present disclosure. The method includes following blocks.

At block 3311, the SDN controller may traverse the IP/MAC address mapping record table named g_olpMacMap.

At block 3312, regarding each of the IP/MAC address mapping records in the IP/MAC address mapping record table, if the difference between the current time and the “updateTime” in the IP/MAC address mapping record is larger than an aging period, the SDN controller may delete the IP/MAC address mapping record.

At block 3313, the SDN controller may traverse the terminal access location record table named g_oMacLocMap.

At block 3314, regarding each of the terminal access location records in the terminal access location record table, if the difference between the current time and the “updateTime” in the terminal access location record is larger than the aging period, the SDN controller may delete the terminal access location record.

By the aforementioned process, the terminal access location record of the terminal device may not be deleted improperly. That is, if the terminal device is online, the terminal access location record of the terminal device may not be deleted, and if the terminal device is offline, the terminal access location record of the terminal device may be deleted when the aging period expires.

It should be noted that, in order to ensure that the SDN controller sends at least one ARP request packet before the IP/MAC address mapping record and the terminal access location record of the terminal device are deleted, the aging period of the IP/MAC address mapping record and the terminal access location record of the terminal device may be larger than an interval of sending the ARP request packet.

In order to describe aspects of the present disclosure more clearly, the SDN shown in FIG. 1 is employed as an example environment for implementing the aspects of the present disclosure. For example, in a scenario, Server1 and Server2 are two terminal devices. Specifically, the IP address of Server1 is IP1, the MAC address of Server1 is MAC1, the IP address of Server2 is IP2, and the MAC address of Server2 is MAC2. When Server1 and Server2 send packets to other devices, the SDN controller may record information related to the two terminal devices at block 31.

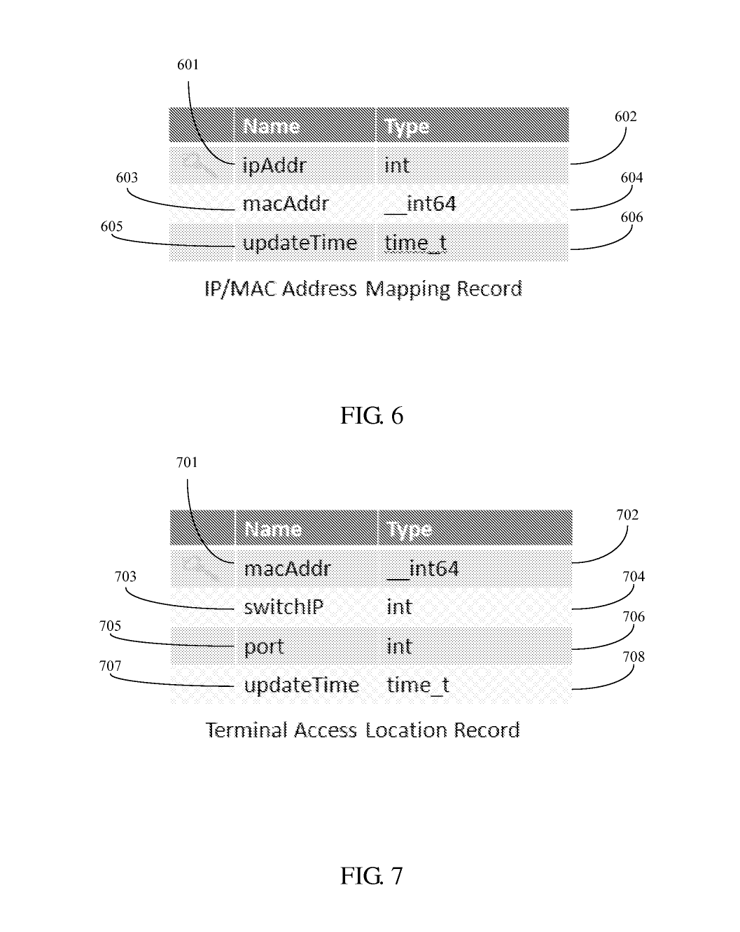

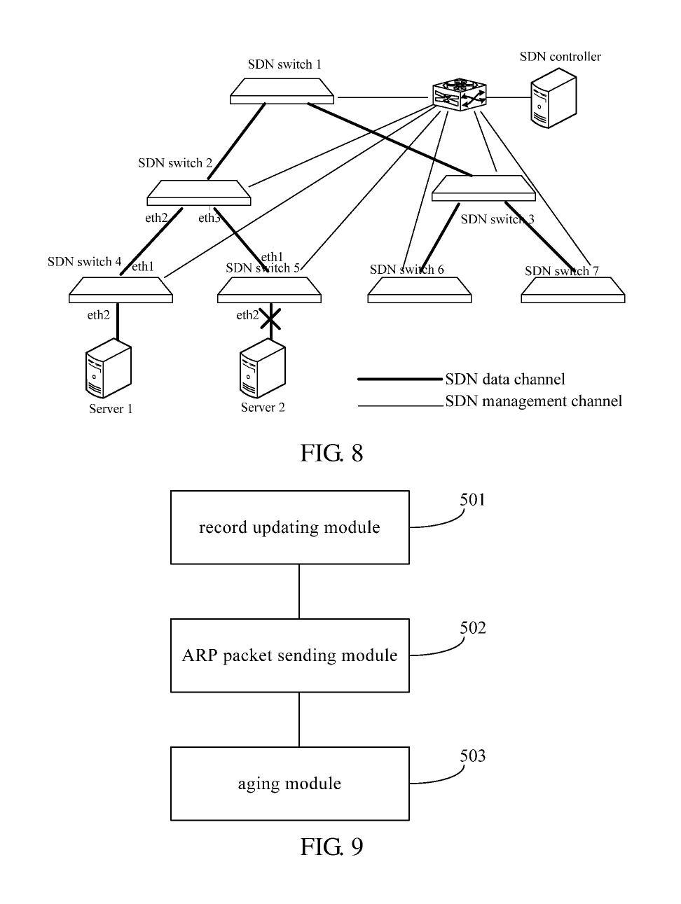

In an example, an IP/MAC address mapping record is shown in FIG. 6. Referring to FIG. 6, ipAddr 601 of Server1 is IP1, and the type of ipAddr 601 is int 602; macAddr 603 of Server1 is MAC1, and the type of macAddr 603 is int64 604; updateTime 605 of Server1 is updateTime1, and the type of updateTime 605 is time_t 606. ipAddr 601 of Server2 is IP2, and the type of ipAddr 601 is int 602; macAddr 603 of Server2 is MAC2, and the type of macAddr 603 is _int64 604; updateTime 605 of Server2 is updateTime2, and the type of updateTime 605 is time_t 606. Accordingly, IP/MAC address mapping records of the two terminal devices may be as follows.

```
g_oIpMacMap =
{
    {IP1, {IP1, MAC1, updateTime1}},
    {IP2, {IP2, MAC2, updateTime2}}
}
```

In an example, a terminal access location record is shown in FIG. 7. Referring to FIG. 7, macAddr 701 of Server1 is MAC1, and the type of macAddr 701 is _int64 702; switchIP 703 of Server1 is Switch4, and the type of switchIP 703 is int 704; port 705 of Server1 is eth2, and the type of port 705 is int 706; updateTime 707 of Server1 is updateTime3, and the type of updateTime 707 is time_t 708. macAddr 701 of Server2 is MAC2, and the type of macAddr 701 is _int64 702; switchIP 703 of Server2 is Switch5, and the type of switchIP 703 is int 704; port 705 of Server2 is eth2, and the type of port 705 is int 706; updateTime 707 of Server2 is updateTime4, and the type of updateTime 707 is time_t 708. Accordingly, terminal access location records of the two terminal devices are as follows.

```
g_oMacLocMap =
{
    {MAC1, {Switch4, eth2, updateTime3}}
    {MAC2, {Switch5, eth2, updateTime4}}
}
```

In an example, it is supposed that Server1 does not send out a packet and Server2 is offline, which is shown in FIG. 6.

According to block 32, the SDN controller may periodically send out an ARP request packet. In an example, an interval of sending the ARP request packet is 1 minute.

Specifically, the SDN controller may first traverse the IP/MAC address mapping record table named g_olpMacMap. The g_olpMacMap may include two IP/MAC address mapping records, i.e., {IP1, {IP1, MAC1, updateTime1}} and {IP2, {IP2, MAC2, updateTime2}}.

For the IP/MAC address mapping record {IP1, {IP1, MAC1, updateTime1}}, it can be learned from the terminal access location record table named g_oMacLocMap that Server1 is connected to Port eth2 of Switch4. Then, the SDN controller may create a first ARP request packet and may send out the first ARP request packet via Port eth2 of Switch4. In an example, the destination IP address of the first ARP request packet is IP1, the destination MAC address of the first ARP request packet is idle, the source IP address of the first ARP request packet is a local IP address of the SDN controller, and the source MAC address of the first ARP request packet is a local MAC address of the SDN controller.

For the IP/MAC address mapping record {IP2, {IP2, MAC2, updateTime2}}, it can be learned from the terminal access location record table named g_oMacLocMap that Server2 is connected to Port eth2 of Switch5. Then, the SDN controller may create a second ARP request packet and may send out the second ARP request packet via Port eth2 of Switch5. In an example, the destination IP address of the second ARP request packet is IP2, the destination MAC address of the second ARP request packet is idle, the source IP address of the second ARP request packet is a local IP address of the SDN controller, and the source MAC address of the second ARP request packet is a local MAC address of the SDN controller.

Taking Server1 as an example, Server1 may receive the first ARP request packet and may send out an ARP response packet accordingly when Server1 is online. The ARP response packet may include an IP address of Server1 (i.e., IP1) and a MAC address of Server1 (i.e., MAC1). Switch4 may receive the ARP response packet via its Port eth2 and may forward the ARP response packet to the SDN controller. The SDN controller may then perform the following operation according to block 31.

In an example, the SDN controller may obtain the source MAC address from the ARP response packet and may determine that the ARP response packet is sent from Server1. Because Port eth2 of Switch4 is not connected to another SDN switch, the SDN controller may search for a terminal access location record of Server1 within the g_oMacLocMap and may modify the “updateTime” previously stored in the terminal access location record of Server1 to the current time (referred to as “updateTime6” hereinafter).

In an example, when it is determined that the packet received by the SDN controller (i.e., the ARP response packet sent by Server1) is an ARP packet, the SDN controller may obtain the source IP address and the source MAC address from the received packet, may search for an IP/MAC address mapping record of Server1 within the g_olpMacMap, and may update the “updateTime” in the IP/MAC address mapping record of Server1 to the current time (referred to as “updateTime6” hereinafter).

A specific example of the g_olpMacMap and the g_oMacLocMap is set forth below. It may be seen that the address update time in the IP/MAC address mapping record of Server1 and the location update time in the terminal access location record of Server1 are changed after block 31.

```
g_oIpMacMap =
{
    {IP1, {IP1, MAC1, updateTime6}},
    {IP2, {IP2, MAC2, updateTime2}}
}
g_oMacLocMap =
{
    {MAC1, {Switch4, eth2, updateTime6}}
    {MAC2, {Switch5, eth2, updateTime4}}
}
```

The SDN controller may periodically (e.g., every 1 minute) age the g_olpMacMap and the g_oMacLocMap. In an example, the aging period is 5 minutes.

In an example, the SDN controller may traverse the IP/MAC address mapping record table named g_olpMacMap. In an example, the g_olpMacMap includes two IP/MAC address mapping records, i.e., {IP1, {IP1, MAC1, updateTime6}} and {IP2, {IP2, MAC2, updateTime2}}. In this example, since {IP1, {IP1, MAC1, updateTime6}} is updated every 1 minute, the difference between the current time and “updateTime6” may not be larger than 5 minutes. Thus, the IP/MAC address mapping record of Server1 may remain and not be deleted. As to {IP2, {IP2, MAC2, updateTime2}}, it is supposed that Server2 is offline and that the SDN controller cannot receive a packet from Server2. After 5 minutes, the difference between the current time and “updateTime2” is larger than 5 minutes, and thus the IP/MAC address mapping record of Server2 may be deleted.

In an example, the SDN controller may traverse the terminal access location record table named g_oMacLocMap. The g_oMacLocMap may include two terminal access location records, i.e., {MAC1, {Switch4, eth2, updateTime6}} and {MAC2, {Switch5, eth2, updateTime4}}. In this example, since {MAC1, {Switch4, eth2, updateTime6}} is updated every 1 minute, the difference between the current time and “updateTime6” may not be larger than 5 minutes. Thus, the terminal access location record of Server1 may remain and not be deleted. As to {MAC2, {Switch5, eth2, updateTime4}}, it is supposed that Server2 is offline and that the SDN controller cannot receive a packet from Server2. After 5 minutes, the difference between the current time and the “updateTime4” is larger than 5 minutes and thus the terminal access location record of Server2 may be deleted.

After the above process, the IP/MAC address mapping record table and the terminal access location record table may be changed as follows:

```
g_oIpMacMap =
{
    {IP1, {IP1, MAC1, updateTime6}}
}
g_oMacLocMap =
{
    {MAC1, {Switch4, eth2, updateTime6}}
}
```

In this way, the terminal access location record of Server1 may not be deleted. Even if Server1 does not send out a packet, the terminal access location record of Server1 may not be deleted incorrectly.

In examples, an SDN controller may periodically receive an ARP packet sent from a terminal device and may update an IP/MAC address mapping record and a terminal access location record of the terminal device in time, thereby keeping the IP/MAC address mapping record and the terminal access location record of the terminal device alive, and further ensuring that the information of the terminal device in the terminal access location record is not deleted.

FIG. 9 is a schematic diagram illustrating a device for keeping a terminal access location record alive, according to an example. The device may be applied to a SDN, such as an OpenFlow network. The SDN may include a terminal device, a SDN switch, and a SDN controller. In an example, the SDN may include a plurality of terminal devices, a plurality of SDN switches, and a SDN controller. In an example, the terminal device may be a server, and the device of keeping the terminal access location record alive may be the SDN controller. As shown in FIG. 9, the device for keeping the terminal access location record alive may include a record updating module 501, an ARP packet sending module 502, and an aging module 503.

The record updating module 501 may update an IP/MAC address mapping record and a terminal access location record of the terminal device when the device receives a packet from the terminal device. The packet from the terminal device is received by the device via an SDN switch.

In an example, the IP/MAC address mapping record of the terminal device is an ARP table which may be illustrated as follows.

| | |
|---|---|
| typedef struct | |
| { | |
| int ipAddr; | //IP address of the terminal device |
| _int64 macAddr; | //MAC address of the terminal device |

```
    time_t updateTime;  //address  update  time  in  the
IP/MAC  address  mapping  record,  and  if  the  difference  between
the  current  time  and  the  address  update  time  is  larger  than  an
aging  period,  the  IP/MAC  address  mapping record would be
deleted
    }SIpMacRec;
    std::map<int,  SIpMacRec  >  g_oIpMacMap,  “int”  indicates
the  IP  address of the terminal device.
```

Further, in this example, the terminal access location record of the terminal device may be defined as follows.

| | |
|---|---|
| typedef struct | |
| { | |
| int switchIP; | //IP address of SDN switch receiving the packet |
| int port; | //port via which the SDN switch receives the packet |

```
  time_t updateTime;  //location  update  time  in  the
terminal  access  location  record,  when  the  difference  between
the  current  time  and  the  location  update  time  is  larger  than
the  aging  period,  the  terminal  access location record would be
deleted
    }SLocRec;
    std::map<_int64,  SLocRec  >  g_oMacLocMap,  “_int64”
indicates  the MAC address of the terminal device.
```

The record updating module 501 may obtain a source IP/MAC address from the packet sent from the terminal device and may determine whether a port via which the SDN switch receives the packet is connected to another SDN switch. If the port via which the SDN switch receives the packet is not connected to another SDN switch, the record updating module 501 may update the IP/MAC address mapping record and the terminal access location record of the terminal device. If the port via which the SDN switch receives the packet is connected to another SDN switch, the record updating module 501 may instruct the SDN switch as to how to handle the packet after a route calculation.

In an example, the record updating module 501 may obtain the source MAC address of the packet and the port via which the SDN switch receives the packet and may search for the terminal access location record corresponding to the source MAC address within a terminal access location record table named g_oMacLocMap. If the terminal access location record is found and the SDN switch and the port of the SDN switch in the record are the same as the SDN switch and the port via which the SDN switch receives the packet, respectively, the record updating module 501 may update the location update time in the terminal access location record to the current time. If the terminal access location record is found, but the SDN switch in the record is different from the SDN switch receiving the packet or the port of the SDN switch in the record is different from the port via which the SDN switch receives the packet, the record updating module 501 may delete the terminal access location record and may add a new terminal access location record corresponding to the source MAC address into the terminal access location record table.

In the new record, the source MAC address of the packet may be used as a key of the record for finding the record within the terminal access location record table, “switchIP” may be the IP address from which the packet is received, “port” may be the switch port of the SDN switch via which the SDN switch receives the packet, and “updateTime” may be the current time. If the terminal access location record is not found, the record updating module 501 may add a new terminal access location record corresponding to the source MAC address into the terminal access location record table. In the new record, the key for finding the record may be the source MAC address, “switchIP” may be the IP address from which the packet is received, “port” may be the switch port of the SDN switch via which the SDN switch receives the packet, and “updateTime” may be the current time.

If the received packet is an ARP packet, the record updating module 501 may obtain a source IP/MAC address of the packet and may search for the IP/MAC address mapping record corresponding to the source MAC address within an IP/MAC address mapping record table named g_olpMacMap. If the IP/MAC address mapping record is found and the MAC address in the record is the same as the source MAC address of the packet, the record updating module 501 may update “updateTime” to the current time. If the IP/MAC address mapping record is found but the MAC address in the record is different from the source MAC address of the packet, the record updating module 501 may delete the IP/MAC address mapping record and may add a new IP/MAC address mapping record corresponding to the source MAC address into the IP/MAC address mapping record table. In the new record, the key of the record may be the source MAC address of the packet, “switchIP” may be the source IP address, and “updateTime” may be the current time. If the IP/MAC address mapping record is not found, the record updating module 501 may add a new IP/MAC address mapping record corresponding to the source MAC address into the IP/MAC address mapping record table. In the new record, the key may be the source MAC address, “switchIP” may be the source IP address, and “updateTime” may be the current time.

The ARP packet sending module 502 may periodically send an ARP request packet and may keep the IP/MAC address mapping record and the terminal access location record of the terminal device alive.

In this example, the ARP packet sending module 502 may traverse the IP/MAC address mapping record table named g_olpMacMap. According to the MAC address contained in the IP/MAC address mapping record of the terminal device, the ARP packet sending module 502 may search for the access location of the terminal device within the terminal access location record table named g_oMacLocMap. If the access location of the terminal device is found, the ARP packet sending module 502 may create an ARP request packet according to the access location of the terminal device and may send out the ARP request packet via the access location of the terminal device. The destination IP address of the ARP request packet may be the IP address of the terminal device, the destination MAC address may be idle, the source IP address may be a local IP address of the SDN controller, and the source MAC address may be a local MAC address of the SDN controller. In an example, the IP address and MAC address contained in the IP/MAC address mapping record are IP1 and MAC1 respectively, the access location of the terminal device is port1 of Switch1, and the IP address of the terminal device is IP1.

If the terminal device is still in the SDN after the ARP request packet is sent out, the terminal device may respond with an ARP response packet. After receiving the ARP response packet from the terminal device, the record updating module 501 may update the IP/MAC address mapping record and the terminal access location record of the terminal device.

The aging module 503 may periodically age the IP/MAC address mapping record and the terminal access location record of the terminal device.

In an example, the aging module 503 may traverse the IP/MAC address mapping record table named g_olpMacMap. Regarding each of IP/MAC address mapping records in the g_olpMacMap, the aging module 503 may delete the IP/MAC address mapping record if the difference between the current time and “updateTime” in the IP/MAC address mapping record is larger than an aging period. The aging module 503 may traverse the terminal access location record table named g_oMacLocMap. Regarding each of terminal access location records in the g_oMacLocMap, the aging module 503 may delete the terminal access location record if the difference between the current time and “updateTime” in the terminal access location record is larger than the aging period.

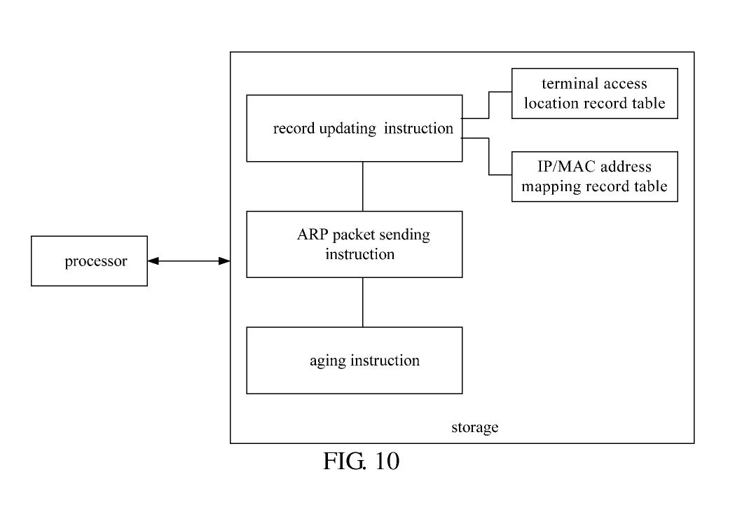

FIG. 10 is a schematic diagram illustrating a device for keeping a terminal access location record alive, according to another example. The device is applied to a SDN, such as an OpenFlow network. The SDN includes a terminal device, a SDN switch, and a SDN controller. The SDN may also include a plurality of terminal devices, a plurality of SDN switches, and a SDN controller. In an example, the terminal device may be a server and the device for keeping the terminal access location record alive may be the SDN controller. As shown in FIG. 10, the device for keeping the terminal access location record alive at least includes a storage and a processor communicating with the storage, in which the storage includes a record updating instruction, an ARP packet sending instruction and an aging instruction that can be executed by the processor. The storage may be a non-transitory computer readable storage medium and the record updating instruction, the ARP packet sending instruction, and the aging instruction may be machine readable instructions stored in the storage. The processor may also execute the machine readable instructions stored in the storage.

The record updating instruction may update an IP/MAC address mapping record and the terminal access location record of the terminal device when the device receives a packet from the terminal device. The packet from the terminal device is received by the device via an SDN switch.

The ARP packet sending instruction may periodically send an ARP request packet and may keep an IP/MAC address mapping record and a terminal access location record of the terminal device alive.

The aging instruction may periodically age the IP/MAC address mapping record and the terminal access location record of the terminal device.

The record updating instruction may determine whether a port via which the SDN switch receives the packet is connected to another SDN switch. If the port via which the SDN switch receives the packet is not connected to another SDN switch, the record updating instruction may update the IP/MAC address mapping record and the terminal access location record of the terminal device.

The record updating instruction may obtain a source MAC address of the packet and a port via which the SDN switch receives the packet, and search for the terminal access location record of the terminal device within a terminal access location record table. If the terminal access location record of the terminal device is found and a SDN switch and a port of the SDN switch in the record are the same as the SDN switch and the port via which the SDN switch receives the packet, respectively, the record updating instruction may update the location update time in the terminal access location record of the terminal device to the current time. If the terminal access location record of the terminal device is found, but the SDN switch in the record is different from the SDN switch receiving the packet or the port of the SDN switch in the record is different from the port via which the SDN switch receives the packet, the record updating instruction may delete the terminal access location record of the terminal device and may add a new terminal access location record of the terminal device into the terminal access location record table.

In the new record, the source MAC address of the packet may be used as a key of the record for finding the record within the terminal access location record table, “switchIP” may be the IP address from which the packet is received, “port” may be the switch port of the SDN switch via which the SDN switch receives the packet, and the location update time may be the current time. If the terminal access location record of the terminal device is not found, the record updating instruction may add a new terminal access location record of the terminal device into the terminal access location record table. In the new record, the source MAC address of the packet may be used as a key of the record for finding the record within the terminal access location record table, “switchIP” may be the IP address rom which the packet is received, “port” may be the switch port of the SDN switch via which the SDN switch receives the packet, and the location update time may be the current time.

If the received packet is an ARP packet, the record updating instruction may obtain a source IP/MAC address of the packet and may search for the IP/MAC address mapping record of the terminal device within an IP/MAC address mapping record table. If the IP/MAC address mapping record of the terminal device is found and a MAC address in the record is the same as the source MAC address of the packet, the record updating instruction may update the address update time in the IP/MAC address mapping record of the terminal device to the current time. If the IP/MAC address mapping record of the terminal device is found but the MAC address in the record is different from the source MAC address of the packet, the record updating instruction may delete the IP/MAC address mapping record of the terminal device and may add a new IP/MAC address mapping record of the terminal device into the IP/MAC address mapping record table. In the new record, the key of the record may be the source MAC address of the packet, “switchIP” may be the source IP address, and the address update time may be the current time. If the IP/MAC address mapping record of the terminal device is not found, the record updating instruction may add a new IP/MAC address mapping record of the terminal device into the IP/MAC address mapping record table. In the new record, the key may be the source MAC address of the packet, “switchIP” may be the source IP address, and the address update time may be the current time.

The ARP packet sending instruction may traverse an IP/MAC address mapping table. According to a MAC address contained in the IP/MAC address mapping record of the terminal device, the ARP packet sending instruction may search for the access location of the terminal device within a terminal access location record table. If the access location of the terminal device is found, the ARP packet sending instruction may create an ARP request packet according to the access location of the terminal device and may send out the ARP request packet via the access location of the terminal device. The destination IP address of the ARP request packet may be the IP address of the terminal device, the destination MAC address may be idle, the source IP address may be a local IP address of the SDN controller, and the source MAC address may be a local MAC address of the SDN controller. The ARP packet sending instruction may further receive an ARP response packet from the terminal device and may keep the IP/MAC address mapping record and the terminal access location record of the terminal device alive.

The aging instruction may traverse an IP/MAC address mapping record table. For each IP/MAC address mapping record in the IP/MAC address mapping record table, the aging instruction may delete the IP/MAC address mapping record if the difference between the current time and the address update time is larger than an aging period. The aging instruction may traverse a terminal access location record table. For each terminal access location record in the terminal access location record table, the aging instruction may delete the terminal access location record if the difference between the current time and the address update time is larger than the aging period.

By the aforementioned processing, the terminal access location record of the terminal device may not be deleted incorrectly. If the terminal device is online, the terminal access location record of the terminal device may not be deleted and if the terminal device is offline, the terminal access location record of the terminal device may be deleted after one aging period.

It should be noted that, in order to ensure that the SDN controller sends at least one ARP request packet before the IP/MAC address mapping record and the terminal access location record of the terminal device are deleted, it may be required that the aging period of the IP/MAC address mapping record and the terminal access location record of the terminal device be larger than an interval of sending the ARP request packet.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method of keeping a terminal access location record alive, applied to a software defined network (SDN), wherein the SDN comprises a terminal device, a SDN switch, and a SDN controller, the method comprising:
receiving, by the SDN controller, a packet from the terminal device;
updating, by the SDN controller, an Internet protocol/media access control (IP/MAC) address mapping record and a terminal access location record of the terminal device;
periodically sending, by the SDN controller, an Address Resolution Protocol (ARP) request packet;
keeping, by the SDN controller, the IP/MAC address mapping record and the terminal access location record of the terminal device alive; and
periodically aging, by the SDN controller, the IP/MAC address mapping record and the terminal access location record of the terminal device.

2. The method of claim 1, wherein the packet from the terminal device is received by the SDN controller via an SDN switch and wherein the SDN controller updating the IP/MAC address mapping record and the terminal access location record of the terminal device comprises:
determining, by the SDN controller, whether a port via which the SDN switch receives the packet is connected to another SDN switch;
in response to a determination that the port via which the SDN switch receives the packet is not connected to another SDN switch, updating the IP/MAC address mapping record and the terminal access location record of the terminal device.

3. The method of claim 1, wherein the packet from the terminal device is received by the SDN controller via an SDN switch and wherein the SDN controller updating the terminal access location record of the terminal device comprises:
obtaining a source MAC address of the packet and a port via which the SDN switch receives the packet;
searching for the terminal access location record of the terminal device within a terminal access location record table;
in response to the terminal access location record of the terminal device being found and a SDN switch and a port of the SDN switch in the terminal access location record are the same as the SDN switch and the port via which the SDN switch receives the packet, respectively, updating location update time in the terminal access location record to current time;
in response to the terminal access location record of the terminal device being found, but the SDN switch in the terminal access location record being different from the SDN switch receiving the packet or the port of the SDN switch in the terminal access location record being different from the port via which the SDN switch receives the packet, deleting the terminal access location record of the terminal device, and adding a new terminal access location record of the terminal device into the terminal access location record table according to the obtained source MAC address as well as an IP address and the port of the SDN switch receiving the packet; and
in response to the terminal access location record of the terminal device not being found, adding a new terminal access location record of the terminal device into the terminal access location record table according to the obtained source MAC address as well as an IP address and the port of the SDN switch receiving the packet, wherein the location update time in the terminal access location record of the terminal device is the current time.

4. The method of claim 1, wherein updating the IP/MAC address mapping record of the terminal device comprises:
in response to the packet received by the SDN controller being an ARP packet, obtaining a source IP/MAC address of the packet and searching for the IP/MAC address mapping record of the terminal device within an IP/MAC address mapping record table;
in response to the IP/MAC address mapping record of the terminal device being found and a MAC address in the IP/MAC address mapping record being the same as the source MAC address of the packet, updating an address update time in the IP/MAC address mapping record to the current time;
in response to the IP/MAC address mapping record of the terminal device being found but the MAC address in the IP/MAC address mapping record being different from the source MAC address of the packet, deleting the IP/MAC address mapping record of the terminal device and adding a new IP/MAC address mapping record of the terminal device into the IP/MAC address mapping record table according to the source MAC address and the source IP address, wherein the address update time in the IP/MAC address mapping record of the terminal device is the current time; and
in response to the IP/MAC address mapping record of the terminal device not being found, adding a new IP/MAC address mapping record of the terminal device into the IP/MAC address mapping record table according to the source MAC address and the source IP, wherein the address update time in the IP/MAC address mapping record of the terminal device is the current time.

5. The method of claim 1, wherein periodically sending the ARP request packet and keeping the IP/MAC address mapping record and the terminal access location record of the terminal device alive comprises:
traversing an IP/MAC address mapping record table;
according to a MAC address contained in the IP/MAC address mapping record of the terminal device, searching for an access location of the terminal device within a terminal access location record table;
in response to the access location of the terminal device being found, creating an ARP request packet according to the access location of the terminal device and sending out the ARP request packet via the access location of the terminal device, wherein the destination IP address of the ARP request packet is the IP address of the terminal device, the destination MAC address is idle, the source IP address is a local IP address of the SDN controller, and the source MAC address is a local MAC address of the SDN controller;
receiving an ARP response packet from the terminal device; and
keeping the IP/MAC address mapping record and the terminal access location record of the terminal device alive.

6. The method of claim 1, wherein periodically aging the IP/MAC address mapping record and the terminal access location record of the terminal device comprises:
traversing an IP/MAC address mapping record table;
regarding each IP/MAC address mapping record in the IP/MAC address mapping record table, deleting the IP/MAC address mapping record if a difference between the address update time in the IP/MAC address mapping record and current time is larger than an aging period;
traversing a terminal access location record table; and
regarding each terminal access location record in the terminal access location record table, deleting the terminal access location record if the difference between the location update time in the terminal access location record and the current time is larger than the aging period.

7. A software defined network (SDN) controller device for keeping a terminal access location record alive, said SDN controller device comprising:
a processor; and
a storage on which is stored machine readable instructions to cause the processor to:
receive a packet from a terminal device;
update an Internet protocol/media access control (IP/MAC) address mapping record and a terminal access location record of the terminal device;
periodically send an Address Resolution Protocol (ARP) request packet;
and keep the IP/MAC address mapping record and the terminal access location record of the terminal device alive; and
periodically age the IP/MAC address mapping record and the terminal access location record of the terminal device.

8. The SDN controller device of claim 7, wherein the packet from the terminal device is received via an SDN switch and wherein the machine readable instructions are further to cause the processor to:
determine whether a port via which a SDN switch receives the packet is connected to another SDN switch;
in response to the port via which the SDN switch receives the packet not being connected to another SDN switch, update the IP/MAC address mapping record and the terminal access location record of the terminal device.

9. The SDN controller device of claim 7, wherein the packet from the terminal device is received via an SDN switch and wherein the machine readable instructions are further to cause the processor to,
obtain a source MAC address of the packet and a port via which a SDN switch receives the packet and search for the terminal access location record of the terminal device within a terminal access location record table;
in response to the terminal access location record of the terminal device being found and an SDN switch and a port of the SDN switch in the terminal access location record being the same as the SDN switch and the port via which the SDN switch receives the packet, respectively, update location update time in the terminal access location record to the current time;
in response to the terminal access location record of the terminal device being found and the SDN switch in the terminal access location record being different from the SDN switch receiving the packet or the port of the SDN switch in the terminal access location record being different from the port via which the SDN switch receives the packet, delete the terminal access location record of the terminal device and add a new terminal access location record of the terminal device into the terminal access location record table according to the source MAC address and an IP address and the port of the SDN switch, wherein the location update time in the terminal access location record of the terminal device is the current time;
in response to the terminal access location record of the terminal device not being found, add a new terminal access location record of the terminal device into the terminal access location record table according to the source MAC address and the IP address and the port of the SDN switch, wherein the location update time in the terminal access location record of the terminal device is the current time.

10. The SDN controller device of claim 7, wherein the machine readable instructions are further to cause the processor to:
in response to the received packet being an ARP packet, obtain a source IP/MAC address of the packet and search for the IP/MAC address mapping record of the terminal device within an IP/MAC address mapping record table;
in response to the IP/MAC address mapping record of the terminal device being found and a MAC address in the IP/MAC address mapping record being the same as the source MAC address of the packet, update address update time in the IP/MAC address mapping record to current time;
in response to the IP/MAC address mapping record of the terminal device being found and the MAC address in the IP/MAC address mapping record being different from the source MAC address of the packet, delete the IP/MAC address mapping record of the terminal device and add a new IP/MAC address mapping record of the terminal device into the IP/MAC address mapping record table according to the source MAC address and the source IP address, wherein the address update time in the IP/MAC address mapping record of the terminal device is the current time;
in response to the IP/MAC address mapping record of the terminal device not being found, add a new IP/MAC address mapping record of the terminal device into the IP/MAC address mapping record table according to the source MAC address and the source IP address, wherein the address update time in the IP/MAC address mapping record of the terminal device is the current time.

11. The SDN controller device of claim 7, wherein the machine readable instructions are further to cause the processor to,
traverse an IP/MAC address mapping record table;
according to a MAC address contained in the IP/MAC address mapping record of the terminal device, search for the access location of the terminal device within a terminal access location record table;
in response to the access location of the terminal device being found, create an ARP request packet according to the access location of the terminal device and send out the ARP request packet via the access location of the terminal device, wherein the destination IP address of the ARP request packet is the IP address of the terminal device, the destination MAC address is idle, the source IP address is a local IP address of the SDN controller device, and the source MAC address is a local MAC address of the SDN controller device;
receiving an ARP response packet from the terminal device; and
keeping the IP/MAC address mapping record and the terminal access location record of the terminal device alive.

12. The SDN controller device of claim 7, wherein the machine readable instructions are further to cause the processor to,
traverse an IP/MAC address mapping record table;
for each IP/MAC address mapping record in the IP/MAC address mapping record table, delete the IP/MAC address mapping record if the difference between a current time and the address update time is larger than an aging period;
traverse a terminal access location record table; and
for each terminal access location record in the terminal access location record table, delete the terminal access location record if the difference between the current time and the address update time is larger than the aging period.

13. A non-transitory computer readable storage medium, comprising computer program codes to cause the processor to,
receive a packet from the terminal device;
update an Internet protocol/media access control (IP/MAC) address mapping record and a terminal access location record of the terminal device;
periodically send an Address Resolution Protocol (ARP) request packet;
keep the IP/MAC address mapping record and the terminal access location record of the terminal device alive; and
periodically age the IP/MAC address mapping record and the terminal access location record of the terminal device.
